(19) United States
(12) Patent Application Publication
(10) Pub. No.: US 2009/0184570 A1
(43) Pub. Date: Jul. 23, 2009

(54) DRIVE UNIT FOR HYDRAULIC PISTON PUMPS WITH AN ECCENTRIC ELEMENT OF A VEHICLE BRAKE SYSTEM

(76) Inventors: Juergen Reiner, Gestratz (DE); Urs Manderscheid, Breisach (DE); Andreas Huditz, Burgberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/279,022

(22) PCT Filed: Jan. 3, 2007
(86) PCT No.: PCT/EP07/50052

§ 371 Date: Aug. 11, 2008

(30) Foreign Application Priority Data
Feb. 14, 2006 (DE) 10 2006 006 684.7

(51) Int. Cl. B60T 8/40

(52) U.S. Cl. 303/116.4

(57) ABSTRACT

The present invention relates to a drive unit for driving at least one hydraulic piston pump, which has a piston, of a vehicle brake system, having a motor shaft which can be rotatably driven. An eccentric is attached to the motor shaft for converting the rotational movement of the driven motor shaft into a translatory movement of the piston. A bearing is attached to the eccentric. In order to avoid transverse forces which result from the eccentricity and which act on the pump piston which is to be driven, the drive unit is provided with an element which absorbs transverse forces. Through the element, the transverse forces which are transmitted by the eccentric which and act at right angles to the longitudinal axis of the piston are absorbed. The element is guided so as to be longitudinally moveable in the direction of the longitudinal axis of the piston and is arranged at least partially between the bearing and the piston.

### BACKGROUND OF THE INVENTION

The invention relates to a drive unit for driving at least one hydraulic pistol pump, having a piston, of a vehicle brake system, having a rotationally drivable motor shaft, an eccentric element, mounted on the motor shaft, for converting the rotary motion of the driven motor shaft into a translational motion of the piston, and a bearing mounted on the eccentric element. The invention furthermore relates to a hydraulic pump system for a vehicle brake system and to a vehicle brake system that both have such a drive unit.

The hydraulic piston pumps used for known vehicle brake systems, such as anti-lock brake systems (ABS), serve to control the pressure in wheel cylinders. In ABS, they are provided for instance for returning brake fluid from one or more wheel brake cylinders to a master cylinder. The ABS often functions in combination with a traction control system (TCS), which likewise makes use of hydraulic piston pumps. Another known system, the so-called electronic stability program (ESP), improves driving safety by a further increment compared to ABS and TCS. While ABS and TCS act in the longitudinal travel direction, ESP affects the transverse dynamics and is therefore in principle a transverse slip control system. For all these systems and others for increasing driving safety, hydraulic piston pumps are used.

For driving the hydraulic piston pumps, known drive units have an eccentric element, for converting the rotary motion of a shaft driven by means of a drive motor into a translational motion of the pistons, which for that purpose are brought with their face end into contact with the outer circumference of a needle bearing mounted on the eccentric element. The needle bearing serves to reduce friction between the pistons and the eccentric element. However, forces that are oriented transversely to the longitudinal axis of the piston, which is a consequence of the eccentricity of the eccentric element, are also transmitted by the eccentric element to the piston resting on the needle bearing. These transverse forces acting on the piston increase the wear of the hydraulic piston pump and thus in the final analysis have an adverse effect on its service life.

### FUNDAMENTAL OBJECT

The object of the invention is to disclose a drive unit for hydraulic piston pumps of a vehicle brake system with which the transverse forces, caused by the eccentricity and acting on the pump pistons to be driven, are avoided.

Attainment According to the Invention of the Object

This object is attained according to the invention with a drive unit as described at the outset for driving at least one hydraulic piston pump, having a piston, of a vehicle brake system, in which the drive unit has an element that absorbs transverse forces, in order to receive transverse forces transmitted by the eccentric element and acting perpendicular to the longitudinal axis of the piston, and the element that absorbs transverse forces is guided longitudinally movably in the direction of the longitudinal axis of the piston and is disposed at least partly between the bearing and the piston.

According to the invention, via an element that absorbs transverse forces and that is guided movably in the direction of the longitudinal axis of the piston to be driven, the translational drive motion of the eccentric element is transmitted to the piston to be driven. The element according to the invention is preferably disposed between the piston to be driven and the bearing mounted on the eccentric element, so that upon rotation of the eccentric element, the element is moved back and forth in the direction of the longitudinal axis of the piston to be driven. This motion is transmitted to the piston to be driven and thus in the final analysis brings about a pumping motion. Because of the longitudinally movable guidance of the element in the direction of the longitudinal axis of the piston, no transverse forces acting at a right angle to the longitudinal axis of the piston can be transmitted to the piston to be driven, since the element according to the invention that absorbs transverse forces can be moved only in the direction of the longitudinal axis of the piston to be driven. The transverse forces are thus received by the element according to the invention and have no effect on the piston that is to be driven.

Viewed all in all, with the drive unit of the invention, wear to the hydraulic piston pumps caused by transverse forces can thus be avoided, and hence in the final analysis their service life can be increased markedly. Moreover, with the translational drive unit of the invention, very high pressures can be attained.

The element that absorbs transverse forces need not, according to the invention, be limited to being disposed between the bearing mounting on the eccentric element and the piston that is to be driven. For instance, it may be an element which surrounds the bearing and which upon rotation of the eccentric element executes a translational motion in the direction of the longitudinal axis of the piston, which motion is transmitted to the piston to be driven.

Advantageous Refinements of the Invention

In an advantageous refinement of the invention, the element that absorbs transverse forces is guided longitudinally movably, in the direction of the longitudinal axis of the piston to be driven, between two linear bearings that are preferably embodied in the form of cylindrical roller bearings or in the form of slide bearings. Linear bearings in the form of cylindrical roller bearings in particular make very low-friction play-free guidance possible and are very undemanding with regard to lubrication and maintenance.

In a practical refinement of the invention, the element that absorbs transverse forces is a cage which has an oblong slot in which the eccentric element and the bearing mounted on it are disposed. In this practical refinement of the invention, the translational drive motion of the eccentric element is transmitted to the piston via the cage guided movably in the direction of the longitudinal axis of the piston to be driven, so that upon rotation of the eccentric element, the guided cage is moved back and forth in the direction of the longitudinal axis of the piston to be driven. This motion is transmitted to the piston to be driven and thus in the final analysis brings about a pumping motion. In this practical refinement of the invention as well, because of the longitudinally movable guidance of the cage in the direction of the longitudinal axis of the piston, no transverse forces can be transmitted to the piston that is to be driven. The forces acting at a right angle to the longitudinal axis of the piston are received by the cage and therefore do not act on the piston that is to be driven.

Preferably, the longitudinal axis of the oblong slot extends perpendicular to the longitudinal axis of the piston, and the length of the oblong slot is increased, compared to the width of the oblong slot, by at least twice the eccentricity of the eccentric element, and the width of the oblong slot is equivalent to the outside diameter of the bearing. By means of this advantageous embodiment of the oblong slot, on the one hand the eccentricity of the eccentric element no longer has any effect in the longitudinal direction of the oblong slot. Moreover, an oblong slot width that is equivalent to the outside diameter of the bearing assures that the eccentricity comes fully into effect in the direction of the longitudinal axis of the piston, so as to assure play-free operation of the hydraulic piston pumps. The comparatively slight transverse forces still transmitted to the cage by the eccentric element despite this design of the oblong slot according to the invention are received by the cage.

In a further advantageous embodiment, the bearing mounted on the eccentric element is a roller bearing, preferably in the form of a needle bearing. Compared to roller bearings in the form of ball bearings and cylindrical roller bearings for the drive unit of the invention, a needle bearing is especially advantageous, because it requires comparatively little space and can withstand relatively high loads.

### BRIEF DESCRIPTION OF THE DRAWING

One exemplary embodiment of a drive unit of the invention will be described below in further detail in conjunction with the drawing.

FIG. 1 is a schematic sectional view of a drive unit with two pump pistons brought into contact with the drive unit.

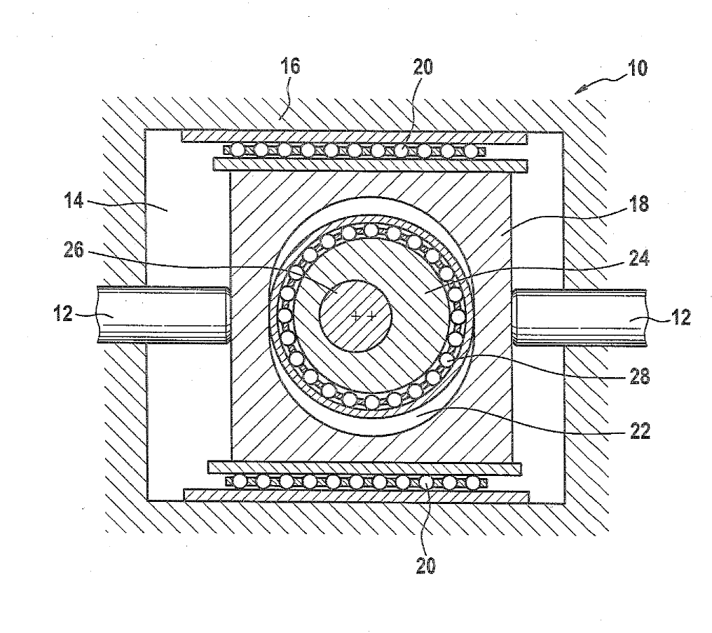

In FIG. 1, a drive unit 10 for driving the pump pistons 12 of two hydraulic piston pumps of the vehicle brake system is shown.

In a hydraulic block 16 of the vehicle brake system, a chamber 14 is embodied. Two pump pistons 12 of two hydraulic piston pumps (not shown), which are received in the hydraulic block 16, protrude into the chamber 14. A motor shaft 26 of a drive motor (not shown) that is likewise received in the hydraulic block 16, extends through the chamber 14. The motor shaft 26 can be driven to rotate by the drive motor. An eccentric element 24 is also mounted on the motor shaft 26, and a needle bearing 28 is mounted along the circumference of this eccentric element.

A cage 18 is disposed in the chamber 14. The cage 18 is guided longitudinally movably in the direction of the longitudinal axes of the pump pistons 12 by means of two linear bearings 20, which are embodied as cylindrical roller bearings; the linear bearings 20 are disposed at the upper and lower boundaries of the chamber 14. The cage 18 has an oblong slot 22, which extends in the direction of the longitudinal axis of the motor shaft 26 and is penetrated by the motor shaft 26. Both the eccentric element 24 and the needle bearing 28 mounted on the eccentric element 24 are disposed inside the oblong slot 22. The cage 18, guided longitudinally movably in the direction of the longitudinal axes of the pump pistons 12 by means of the two linear bearings 20, along with the eccentric element 24 with the needle bearing 28 mounted on the eccentric element 24, and in conjunction with the motor shaft 26 and the drive motor, form the drive unit 10 for driving the pump pistons 12.

The rotary motion of the motor shaft 26 driven by means of the drive motor is converted via the eccentric element 24 into a translational motion of the guided cage 18 in the direction of the longitudinal axis of the pump pistons 12 and is transmitted, for achieving a pumping motion, to the pump pistons 12 that are made to contact the outer wall of the cage 18. The needle bearing 28 serves to reduce friction between the eccentric element 24 and the inner wall of the cage 18. Because of the guidance of the cage 18 between the two linear bearings 20, no transverse forces that promote wear and act at right angles to the longitudinal axis of the pump pistons 12 can be transmitted to the pump pistons 12 by the eccentric element 24, since the cage 18 can be moved only in the direction of the longitudinal axis of the pump pistons 12 that are to be driven.

The pump pistons 12 of the hydraulic piston pumps are brought with their face ends into contact with the outer wall of the cage 18. In order to assure that the pump pistons 12 will always contact the outer wall of the cage 18 while the pump pistons 12 are being driven, they are pressed against the outer wall of the cage 18, for instance by means of tensed helical springs provided in the hydraulic piston pumps.

The oblong slot 22 in the cage 18 is embodied such that a play-free drive in the direction of the longitudinal axes of the pumps can be assured at all times, and moreover, the transverse forces transmitted to the cage 18 by the eccentric element 24 can be reduced to a minimum. For that purpose, on the one hand, the longitudinal axis of the oblong slot 22 extends at right angles to the longitudinal axis of the pump pistons 12. In addition, the length of the oblong slot 22 compared to the width of the oblong slot 22 is increased by at least twice the eccentricity of the eccentric element 24. As a result of the thus-selected length and orientation of the oblong slot 22 relative to the longitudinal axis of the pump pistons 12, the eccentricity of the eccentric element 24 no longer has any effect in the longitudinal direction of the oblong slot 22. The transverse forces, caused by the eccentricity of the eccentric element 24, acting at right angles to the longitudinal axis of the pump piston 12, and transmitted to the cage 18 are thus reduced to a minimum.

The width of the oblong slot 22 is moreover equivalent to the outside diameter of the needle bearing 28. By means of a thus-selected oblong slot width, the eccentricity of the eccentric element 24 comes fully into effect in the direction of the longitudinal axes of the pump pistons 12, thereby making a play-free drive of the hydraulic piston pumps possible. Any force components still transmitted by the eccentric element 24 to the cage 18 and acting transversely to the longitudinal axis of the pump pistons are received by the cage 18 and finally transmitted to the two linear bearings 20.

FIG. 1 shows the cage 18 in a right-hand terminal position, in which the pump piston 12, brought into contact with the right-hand outer wall of the cage 18, is at its bottom dead center. Upon clockwise rotation of the motor, a corresponding rotation of the eccentric element 24 takes place, and as a result the cage 18 is moved toward its left-hand terminal position, with an attendant motion of the right-hand pump piston 12 in the direction of top dead center.

Overall, the drive unit 10 shown in FIG. 1 makes a play-free drive of the pump pistons 12 possible, with which transverse forces acting perpendicular to the longitudinal axis of the pump pistons 12 and transmitted by the eccentric element 24 can be reduced to a minimum. Only the forces oriented in the longitudinal direction of the pump pistons act on the pump pistons 12 that are to be driven, and as a result, the tendency of the driven hydraulic piston pumps to wear is reduced markedly.

1-8. (canceled)

9. A drive unit for driving at least one hydraulic piston pump of a vehicle brake system, comprising:
a piston having a longitudinal axis;
a rotationally driven motor shaft;
an eccentric element mounted on the motor shaft, for converting the rotary motion of the driven motor shaft into a translational motion of the piston;
a bearing mounted on the eccentric element; and
an element disposed at least partly between the bearing and the piston, the element absorbing transverse forces transmitted by the eccentric element and forces acting perpendicular to the longitudinal axis of the piston, wherein the element is guided longitudinally movably in a direction of the longitudinal axis of the piston.

10. The drive unit as defined by claim 9, wherein the element that absorbs transverse forces is guided longitudinally movably between two linear bearings.

11. The drive unit as defined by claim 10, wherein the linear bearings are designed in the form of cylindrical roller bearings.

12. The drive unit as defined by claim 9, wherein the element that absorbs transverse forces is embodied by a cage which has an oblong slot in which the eccentric element and the bearing mounted on the eccentric element are disposed.

13. The drive unit as defined by claim 10, wherein the element that absorbs transverse forces is embodied by a cage which has an oblong slot in which the eccentric element and the bearing mounted on the eccentric element are disposed.

14. The drive unit as defined by claim 11, wherein the element that absorbs transverse forces is embodied by a cage which has an oblong slot in which the eccentric element and the bearing mounted on the eccentric element are disposed.

15. The drive unit as defined by claim 12, wherein a longitudinal axis of the oblong slot extends perpendicular to the longitudinal axis of the piston, and the length of the oblong slot is increased, compared to the width of the oblong slot, by at least twice the eccentricity of the eccentric element, and the width of the oblong slot is equivalent to the outside diameter of the bearing.

16. The drive unit as defined by claim 13, wherein a longitudinal axis of the oblong slot extends perpendicular to the longitudinal axis of the piston, and the length of the oblong slot is increased, compared to the width of the oblong slot, by at least twice the eccentricity of the eccentric element, and the width of the oblong slot is equivalent to the outside diameter of the bearing.

17. The drive unit as defined by claim 14, wherein a longitudinal axis of the oblong slot extends perpendicular to the longitudinal axis of the piston, and the length of the oblong slot is increased, compared to the width of the oblong slot, by at least twice the eccentricity of the eccentric element and the width of the oblong slot is equivalent to the outside diameter of the bearing.

18. The drive unit as defined by claim 9, wherein the bearing is a roller bearing, preferably in the form of a needle bearing.

19. The drive unit as defined by claim 10, wherein the bearing is a roller bearing, preferably in the form of a needle bearing.

20. The drive unit as defined by claim 11, wherein the bearing is a roller bearing, preferably in the form of a needle bearing.

21. The drive unit as defined by claim 12, wherein the bearing is a roller bearing, preferably in the form of a needle bearing.

22. The drive unit as defined by claim 15, wherein the bearing is a roller bearing, preferably in the form of a needle bearing.

23. A hydraulic pump system for a vehicle brake system, having at least one hydraulic piston pump and at least one drive unit as defined by claim 9.

24. A hydraulic pump system for a vehicle brake system, having at least one hydraulic piston pump and at least one drive unit as defined by claim 10.

25. A hydraulic pump system for a vehicle brake system, having at least one hydraulic piston pump and at least one drive unit as defined by claim 12.

26. A vehicle brake system, having a hydraulic pump system as defined by claim 23.

27. A vehicle brake system, having a hydraulic pump system as defined by claim 24.

28. A vehicle brake system, having a hydraulic pump system as defined by claim 25.
